(19) United States
(12) Patent Application Publication
(10) Pub. No.: US 2019/0276298 A1
(43) Pub. Date: Sep. 12, 2019

(54) Liquid Dispense System

(71) Applicant: Dispenser Packaging, LLC, Lakeland, FL (US)

(72) Inventors: Henry Russell Spivey, JR., Lakeland, FL (US); Randall S. Brown, Kennesaw, GA (US); Joseph T. Norris, Cumming, GA (US)

(21) Appl. No.: 16/296,432

(22) Filed: Mar. 8, 2019

Related U.S. Application Data
(60) Provisional application No. 62/640,991, filed on Mar. 9, 2018.
(60) Provisional application No. 62/642,381, filed on Mar. 13, 2018.
(60) Provisional application No. 62/738,534, filed on Sep. 28, 2018.

(51) Int. Cl. B67D 1/08

(52) U.S. Cl. CPC B67D 1/0804; B67D 1/0807; B67D 2001/0091; B67D 2210/00146; B67D 2210/00034

(57) ABSTRACT

A liquid dispense system has a container having an open end and a sidewall defining a container interior, and a fitment enclosing the open end of the container. The sidewall has at least one vent. The fitment has a hollow body with a partition extending across an interior of the hollow body, the partition having at least one aperture. The fitment further has a valve connected to the partition and being movable between a normally-closed position and an open position. The at least one vent is covered by a protective membrane configured to filter air that enters the container interior as liquid is dispensed from the container interior when the valve is in the open position.

### CROSS-REFERENCE TO RELATED APPLICATIONS

This application claims priority to U.S. Provisional Application No. 62/640,991, filed, Mar. 9, 2018; U.S. Provisional Application No. 62/642,381, filed Mar. 13, 2018; and U.S. Provisional Application No. 62/738,534, filed Sep. 28, 2018, the disclosures of which are hereby incorporated by reference in their entirety.

### BACKGROUND OF THE DISCLOSURE

### Field of the Disclosure

The present disclosure is generally related to a liquid dispense system configured for dispensing liquid from a container, and, in particular, to a liquid dispense system configured for use with equipment or apparatus for dispensing or dosing beverages, food products, chemicals, soaps, or pharmaceutical products.

### Description of Related Art

A variety of dispensing equipment or apparatus exist for dispensing liquid products. An example of a conventional dispensing equipment or apparatus is a liquid dispense system having one or more dispense cartridges or containers with a dispense fitment or valve configured for dosing the liquid from the cartridge or container. Dispense cartridges or containers have a hollow interior configured for filling with a liquid, such as a beverage, a food product, a chemical, a soap, or a pharmaceutical product. Each dispense cartridge or container has the dispense fitment with a valve that is operated by an actuator or vacuum pump to dispense the liquid from the dispense cartridge or container for mixing with a diluent, such as water.

Many conventional dispense cartridges or containers require a venting mechanism, such as a vent opening, to allow introduction of air into the cartridge or container as the liquid is dispensed. In some examples, the vent opening is initially closed with a molded vent tab, a paper label, or a plug to facilitate transport and sterility of the concentrate inside the container. In addition, the fitment is protected by a removable cap. During loading of the container into the dispensing machine, the user must open the vent on the dispense cartridge or container to allow air to displace the concentrate that is dispensed from the dispense cartridge or container. The plug is typically molded as an integral part of the container and must be twisted or otherwise removed to open the vent. In many cases, the plug may be difficult to remove from the container to open the vent. In examples where a paper label covers the vent opening, the paper label is applied during a secondary step in the container manufacturing process. A disadvantage of these conventional containers is that the paper label or molded vent tab may be difficult to remove from the container to open the vent and requires a separate manufacturing step.

Air that is introduced into the container through the vent opening interacts directly with the liquid contained in the container. In this manner, the air entering the container may carry contaminates which may contaminate the liquid within the container. Such contamination may be contrary to industry codes prohibiting contact of unfiltered air with the liquid within the container. For example, in the beverage dispensing industry, contact of unfiltered air with the liquid inside the container is contrary to the provisions of Food and Drug Administration Code 2017, section 4-204.13 “Dispensing Equipment, Protection of Equipment and Food”, which requires that barriers be provided so that the only liquid entering the food container is the liquid that is to be dispensed when the dispensing machine's mechanism is activated. This food code further recognizes that providing a direct opening into the container allows contaminants to access the contents of the container.

Some conventional dispense cartridges or containers are also prone to contaminating the liquid contents of the cartridge or container with residual liquid left over in the dispensing equipment from the previous cartridge or container that has been removed from the dispensing equipment. For example, residual liquid may remain in a nest or receiving area of the dispensing equipment when a used cartridge or container is removed. When a new cartridge or container is inserted into the nest or receiving area, at least a portion of the residual liquid may be forced back into the interior of the cartridge or container, or the liquid in the new cartridge or container can freely mix with the liquid in the nest, thereby contaminating the liquid therein. This is contrary to provisions of Food Code 2017, section 4-204.13 “Dispensing Equipment, Protection of Equipment and Food”, which states that “[b]arriers need to be provided so that the only liquid entering the food container is liquid intended to be dispensed when the machine's mechanism is activated.”

Conventional dispense fitments for dispense cartridges or containers often have multiple parts and are difficult and expensive to manufacture. For example, each dispense fitment may have one or more valves, seals, and other components that must be carefully assembled together to ensure proper functionality of the fitment. Such complexity increases the manufacturing time and cost of the fitment. In addition, most dispense fitments are designed to be applied after the liquid product has been filled in the dispense cartridge or container, which may expose the dispense cartridge or container to contamination during shipment. Furthermore, conventional dispense fitments designed for dispense cartridges or containers have one-way valves which only allow for the liquid to be dispensed by vacuum or gravity after the product is filled. In addition, conventional dispense cartridges, containers or fitments lack enhanced barrier protection to the liquid product within the container, which may preserve product integrity and extend shelf life.

In view of these and other disadvantages of conventional dispense cartridges, containers and fitments or valves therefor, there is a need in the art for new and improved liquid dispense systems that overcome these shortcomings.

### SUMMARY OF THE DISCLOSURE

The present disclosure generally relates to a liquid dispense system configured for dispensing liquid from a container, and, in particular, to a liquid dispense system configured for use with equipment or apparatus for dispensing or dosing beverages, food products, chemicals, soaps, or pharmaceutical products.

In some examples or aspects of the present disclosure, a liquid dispense system may have a container having an open end and a sidewall defining a container interior. The sidewall may have at least one vent. The liquid dispense system may further have a fitment enclosing the open end of the container. The fitment may have a hollow body having a partition extending across an interior of the hollow body. The partition may have at least one aperture, and a valve connected to at least a portion of the partition. The valve may be movable between a normally-closed position seated against the distal surface of the partition to close the at least one aperture, and an open position at least partially unseated from the distal surface of the partition to open the at least one aperture. The at least one vent may be covered by a protective membrane configured to filter air that enters the container interior as liquid is dispensed from the container interior when the valve is in the open position.

In some examples or aspects of the present disclosure, the valve may have a stem portion with a proximal end connected to the partition and a seal portion extending radially outward from a distal end of the stem portion. The seal portion may be configured for sealing the at least one aperture. The hollow body may have a proximal portion connected to the open end of the container and a distal portion configured for interacting with a dispensing apparatus. The at least one vent may be positioned opposite the open end of the container.

In some examples or aspects of the present disclosure, t. The hollow body of the fitment may be made from a first material and the valve is made from a second material different from the first material. The first material may be high density polyethylene. The second material may be a thermoplastic elastomer.

In some examples or aspects of the present disclosure, the open end of the container may have a first connection element and a proximal portion of the fitment may have a second connection element configured for connecting with the first connection element. The first connection element may be a male thread and wherein the second connection element may be a female thread releasably connectable with the male thread.

In some examples or aspects of the present disclosure, at least one of open end of the container and a proximal portion of the fitment may have a first seal configured for sealing the open end of the container when the proximal portion of the fitment is connected to the open end of the container. An outer surface of the distal end of the fitment may have a second seal.

In some examples or aspects of the present disclosure, a protective cap may at least partially surround the distal portion of the fitment. The protective cap may have a removable strip configured for preventing removal of the protective cap from the distal portion of the fitment prior to removal of the removable strip. An outer surface of the distal portion of the fitment may have a flange protruding in a radially outward direction. The flange may be configured for engaging a lip on the removable strip to prevent removal of the protective cap from the distal portion of the fitment prior to removal of the removable strip.

In some examples or aspects of the present disclosure, a liquid dispense system may have a container having an open end and a sidewall defining a container interior. The sidewall may have at least one vent. The liquid dispense system may further have a fitment enclosing the open end of the container. The fitment may have a hollow body having a proximal portion connected to the open end of the container and a distal portion configured for interacting with a dispensing apparatus. The fitment may further have a partition extending across an interior of the hollow body, the partition having at least one aperture. The fitment may further have a valve including a stem portion with a proximal end connected to the partition and a seal portion extending radially outward from a distal end of the stem portion. The seal portion may be movable between a normally-closed position seated against the distal surface of the partition to close the at least one aperture, and an open position at least partially unseated from the distal surface of the partition to open the at least one aperture. The at least one vent may be covered by a protective membrane configured to filter air that enters the container interior as liquid is dispensed from the container interior when the valve is in the open position.

In some examples or aspects of the present disclosure, the hollow body of the fitment may be made from a first material and the valve may be made from a second material different from the first material. The first material may be high density polyethylene, and the second material may be a thermoplastic elastomer. At least one of open end of the container and a proximal portion of the fitment may have a first seal configured for sealing the open end of the container when the proximal portion of the fitment is connected to the open end of the container. An outer surface of the distal end of the fitment may have a second seal.

Various other examples or aspects of the present disclosure are recited in one or more of the following numbered clauses:

Clause 1. A liquid dispense system comprising: a container having an open end and a sidewall defining a container interior, the sidewall having at least one vent; and a fitment enclosing the open end of the container, the fitment comprising: a hollow body having a partition extending across an interior of the hollow body, the partition having at least one aperture; and a valve connected to at least a portion of the partition, the valve movable between a normally-closed position seated against the distal surface of the partition to close the at least one aperture, and an open position at least partially unseated from the distal surface of the partition to open the at least one aperture, wherein the at least one vent is covered by a protective membrane configured to filter air that enters the container interior as liquid is dispensed from the container interior when the valve is in the open position.

Clause 2. The liquid dispense system according to clause 1, wherein the valve has a stem portion with a proximal end connected to the partition and a seal portion extending radially outward from a distal end of the stem portion, the seal portion configured for sealing the at least one aperture.

Clause 3. The liquid dispense system according to clause 1 or 2, wherein the hollow body has a proximal portion connected to the open end of the container and a distal portion configured for interacting with a dispensing apparatus.

Clause 4. The liquid dispense system according to any of clauses 1-2, wherein the at least one vent is positioned opposite the open end of the container.

Clause 5. The liquid dispense system according to any of clauses 1-4, wherein the protective membrane is made from a PTFE material.

Clause 6. The liquid dispense system according to any of clauses 1-5, wherein the hollow body of the fitment is made from a first material and the valve is made from a second material different from the first material.

Clause 7. The liquid dispense system according to claim 6, wherein the first material is high density polyethylene.

Clause 8. The liquid dispense system according to clause 6 or 7, wherein the second material is a thermoplastic elastomer.

Clause 9. The liquid dispense system according to any of clauses 1-8, wherein the open end of the container has a first connection element and wherein a proximal portion of the fitment has a second connection element configured for connecting with the first connection element.

Clause 10. The liquid dispense system according to clause 9, wherein the first connection element is a male thread and wherein the second connection element is a female thread releasably connectable with the male thread.

Clause 11. The liquid dispense system according to any of clauses 1-10, wherein at least one of the open end of the container and a proximal portion of the fitment has a first seal configured for sealing the open end of the container when the proximal portion of the fitment is connected to the open end of the container.

Clause 12. The liquid dispense system according to any of clauses 1-11, wherein an outer surface of a distal end of the fitment has a second seal.

Clause 13. The liquid dispense system according to any of clauses 1-12, further comprising a protective cap at least partially surrounding the distal portion of the fitment.

Clause 14. The liquid dispense system according to clause 13, wherein the protective cap has a removable strip configured for preventing removal of the protective cap from the distal portion of the fitment prior to removal of the removable strip.

Clause 15. The liquid dispense system according to clause 14, wherein an outer surface of the distal portion of the fitment has a flange protruding in a radially outward direction, the flange configured for engaging a lip on the removable strip to prevent removal of the protective cap from the distal portion of the fitment prior to removal of the removable strip.

Clause 16. A liquid dispense system comprising: a container having an open end and a sidewall defining a container interior, the sidewall at least one vent; and a fitment enclosing the open end of the container, the fitment comprising: a hollow body having a proximal portion connected to the open end of the container and a distal portion configured for interacting with a dispensing apparatus; a partition extending across an interior of the hollow body, the partition having at least one aperture; and a valve having a stem portion with a proximal end connected to the partition and a seal portion extending radially outward from a distal end of the stem portion, the seal portion movable between a normally-closed position seated against the distal surface of the partition to close the at least one aperture, and an open position at least partially unseated from the distal surface of the partition to open the at least one aperture, wherein the at least one vent is covered by a protective membrane configured to filter air that enters the container interior as liquid is dispensed from the container interior when the valve is in the open position.

Clause 17. The liquid dispense system according to clause 16, wherein the hollow body of the fitment is made from a first material and the valve is made from a second material different from the first material.

Clause 18. The liquid dispense system according to clause 17, wherein the first material is high density polyethylene, and wherein the second material is a thermoplastic elastomer.

Clause 19. The liquid dispense system according to any of clauses 16-18, wherein at least one of the open end of the container and a proximal portion of the fitment has a first seal configured for sealing the open end of the container when the proximal portion of the fitment is connected to the open end of the container.

Clause 20. The liquid dispense system according to any of clauses 16-19, wherein an outer surface of the distal end of the fitment has a second seal.

Further details and advantages of the various examples or aspects described in detail herein will become clear upon reviewing the following detailed description of the various examples in conjunction with the accompanying drawing figures.

### BRIEF DESCRIPTION OF THE DRAWINGS

FIG. 1 is a front perspective view of a dispensing machine for use with a liquid dispense system in accordance with some examples or aspects of the present disclosure;

FIG. 2 is a detailed, side cross-sectional view of a receiving space or nest and an actuator of a dispensing machine shown in FIG. 1;

FIG. 3A is a side view of a liquid dispense system in accordance with some examples or aspects of the present disclosure;

FIG. 3B is an exploded side view of the liquid dispense system shown in FIG. 3A;

FIG. 4A is a side view of a fitment configured for use with a liquid dispense system in accordance with some examples or aspects of the present disclosure;

FIG. 4B is a side view of the fitment shown in FIG. 4A with a protective cover removed;

FIG. 4C is a side cross-sectional view of the fitment shown in FIG. 4A taken along line A-A;

FIG. 4D is a top view of the fitment shown in FIG. 4A;

FIG. 5A is a bottom view of a valve seat of the fitment shown in FIG. 4C;

FIG. 5B is a side cross-sectional view of the valve seat shown in FIG. 5A taken along line B-B;

FIG. 6A is a bottom view of a valve of the fitment shown in FIG. 4C;

FIG. 6B is a side cross-sectional view of the valve shown in FIG. 6A taken along line C-C;

FIG. 7A is a perspective view of a container of the liquid dispense system shown in FIG. 3A;

FIG. 7B is a side cross-sectional view of the container shown in FIG. 7A;

FIG. 7C is an enlarged view of Detail 7C shown in FIG. 7B;

FIG. 7D is an enlarged view of Detail 7D shown in FIG. 7B;

FIG. 8A is a side cross-sectional view of the liquid dispense system shown in FIG. 3A with the container shown fully filled with liquid;

FIG. 8B is a side cross-sectional view of the liquid dispense system shown in FIG. 3A with the container shown partially filled with liquid;

FIG. 9 is a side cross-sectional view of a fitment for use with a liquid dispense system in accordance with some examples or aspects of the present disclosure;

FIG. 10A is a bottom view of the fitment shown in FIG. 9;

FIG. 10B is a top view of the fitment shown in FIG. 9;

FIG. 11 is a side cross-sectional view of a fitment for use with a liquid dispense system in accordance with some examples or aspects of the present disclosure;

FIG. 12A is a top view of the fitment shown in FIG. 11;

FIG. 12B is a bottom view of the fitment shown in FIG. 11;

FIG. 13A is a side view of an insert for use with the fitment shown in FIG. 11; and

FIG. 13B is a top view of the insert shown in FIG. 13A;

FIG. 14A is a side cross-sectional view of a container for use with a liquid dispense system in accordance with some examples or aspects of the present disclosure;

FIG. 14B is an enlarged view of a vent shown in FIG. 14A; and

FIGS. 15A-15C are detailed side cross-sectional views of a container having a vent opening with a protective membrane in accordance with some examples or aspects of the present disclosure.

### DETAILED DESCRIPTION OF THE DISCLOSURE

The illustrations generally show preferred and non-limiting examples or aspects of the systems and methods of the present disclosure. While the description presents various examples or aspects of a liquid dispense system and a method of dispensing liquid using the liquid dispense system, it should not be interpreted in any way as limiting the disclosure. Furthermore, modifications, concepts, and applications of the disclosure's aspects are to be interpreted by those skilled in the art as being encompassed, but not limited to, the illustrations and descriptions herein. Any and all such modifications, variations, equivalents, and alternatives are intended to fall within the spirit and scope of the present disclosure.

For purposes of the description hereinafter, the terms “upper”, “lower”, “right”, “left”, “vertical”, “horizontal”, “top”, “bottom”, “lateral”, “longitudinal”, and derivatives thereof shall relate to the disclosure as it is oriented in the drawing figures.

When used with reference to a fitment of a liquid dispense system, the term “proximal” means a portion of a fitment that is nearest to a container of the liquid dispense system.

When used with reference to a fitment of a liquid dispense system, the term “distal” means a portion of a fitment that is furthest away from a container of the liquid dispense system.

As used herein, the terms “parallel” or “substantially parallel” mean a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values.

As used herein, the terms “perpendicular” or “substantially perpendicular” mean a relative angle as between two objects (if extended to theoretical intersection), such as elongated objects and including reference lines, that is from 85° to 90°, or from 87° to 90°, or from 152° to 90°, or from 89° to 90°, or from 89.5° to 90°, or from 89.75° to 90°, or from 89.9° to 90°, inclusive of the recited values.

The term “at least” is synonymous with “greater than or equal to”.

As used herein, “at least one of” is synonymous with “one or more of”. For example, the phrase “at least one of A, B, or C” means any one of A, B, or C, or any combination of any two or more of A, B, or C. For example, “at least one of A, B, and C” includes A alone; or B alone; or C alone; or A and B; or A and C; or B and C; or all of A, B, and C.

The term “includes” is synonymous with “comprises”.

It should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

It is to be understood, however, that the disclosure may assume alternative variations and step sequences, except where expressly specified to the contrary. It is also to be understood that the specific devices and processes illustrated in the attached drawings, and described in the following specification, are simply exemplary aspects of the disclosure. Hence, specific dimensions and other physical characteristics related to the examples disclosed herein are not to be considered as limiting.

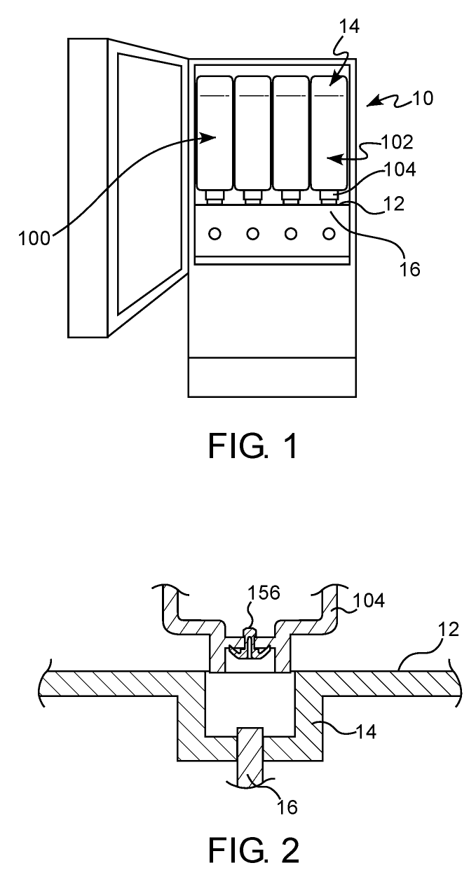

Referring to the drawings, in which like reference characters refer to the like parts throughout the several views thereof, FIG. 1 illustrates a dispensing apparatus 10 configured for use with a liquid dispense system 100 in accordance with some examples or aspects of the present disclosure. Generally, the dispensing apparatus 10 may be configured as a beverage dispensing system configured to receive one or more liquid dispense systems 100. Each liquid dispense system 100 has a container 102 filled with a liquid. In some examples or aspects, the liquid may be a liquid beverage concentrate. In other examples or aspects, the liquid may be a liquid food product, a chemical, such as an insecticide or a herbicide, a soap, or a pharmaceutical product. In further examples or aspects, the liquid within the container 102 of the liquid dispense system 100 may be any liquid substance that is desired to be dispensed in precise quantities.

With continued reference to FIG. 1, the dispensing apparatus 10 may be a Quest 2000, Quest 4000, or a Cold Brew Coffee Machine made by Cornelius of Osseo, Minn., or JDF-2, JDF-4, or Nitro Cold Brew Coffee Machine made by BUNN of Springfield, Ill. The dispensing apparatus 10 may have one or more receiving spaces 12 each configured for receiving a liquid dispense system 100. Each receiving space 12 has a nest 14 for receiving a fitment 104 of the container 102 of the liquid dispense system 100. The dispensing apparatus 10 has one or more actuators 16, with each actuator 16 configured for being operatively connected to the fitment 104 of each container 102 for dispensing the liquid from the container 102 and mixing it with a diluent, such as water. In some examples or aspects, the one or more actuators 16 may be electrically, mechanically, or pneumatically actuated valves. For example, the one or more actuators 16 may be a pneumatically actuated valves configured for dispensing liquid from the container 102 via the fitment 104 by drawing a vacuum within the container 102.

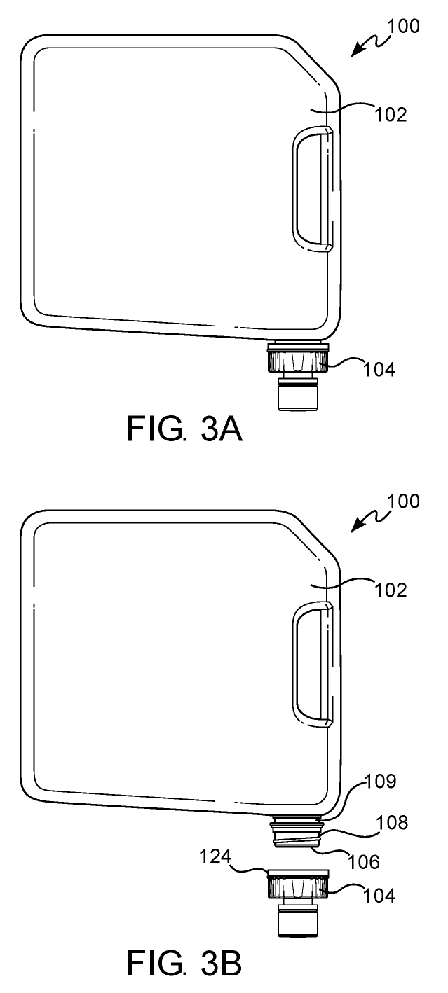

With reference to FIG. 2, the nest 14 may be configured as a recess in the receiving space 12. The nest 14 may be shaped to receive at least a portion of the fitment 104, such as the distal end of the fitment 104. The actuator 16 is configured for interacting with a valve on the fitment 104. For example, the actuator 16 may be configured for opening the valve via vacuum.

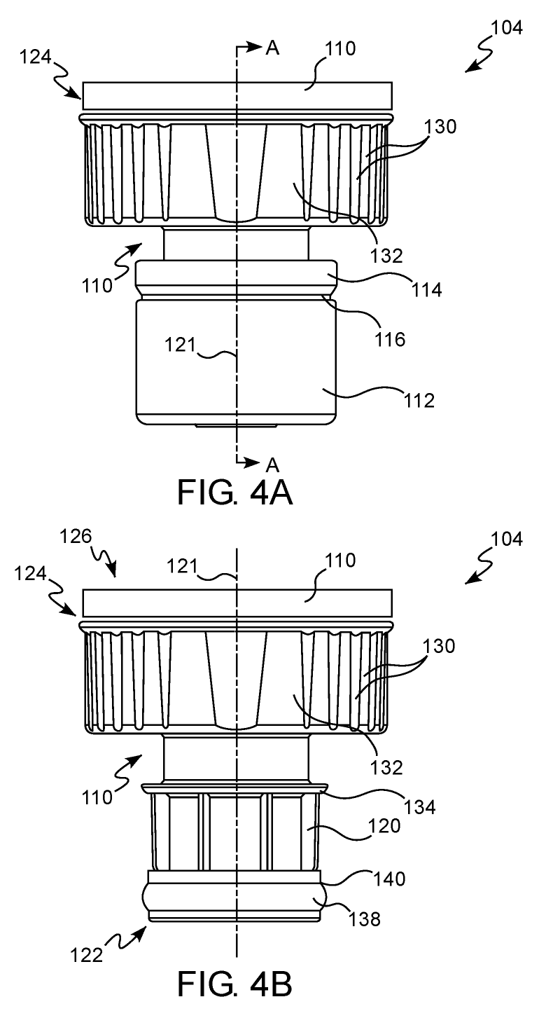

With reference to FIGS. 3A-3B, the liquid dispense system 100 is shown in accordance with some examples or aspects of the present disclosure. The liquid dispense system 100 has the container 102 and the fitment 104. The fitment 104 is configured for enclosing an open end 106 of the container 102. In some examples or aspects, the container 102 and the fitment 104 are removably connected to each other. For example, the container 102 may have a first connection element 108 (shown in FIG. 3B) on a discharge spout 109 of the open end 106 that is configured for connecting to a corresponding second connection element on the fitment 104. In some examples or aspects, the first connection element 108 on the discharge spout 109 of the container 102 may be a male or a female thread that is configured for threadably mating with a corresponding female or male thread on the fitment 104. In other examples or aspects, the first connection element 108 may rely on, for example, a friction fit, an interference fit, an adhesive fit, a clip, connector, fastener, or any other removable connection mechanism for removably connecting the fitment 104 to the container 102. When connected, the fitment 104 seals the container interior to prevent liquid from leaking out of the container interior. In some examples or aspects, the container 102 and the fitment 104 may be non-removably connected together. For example, the container 102 and the fitment 104 may be formed separately and joined together in a manner such that they cannot be separated. In further examples or aspects, the container 102 and the fitment 104 may be formed as a unitary, monolithic structure.

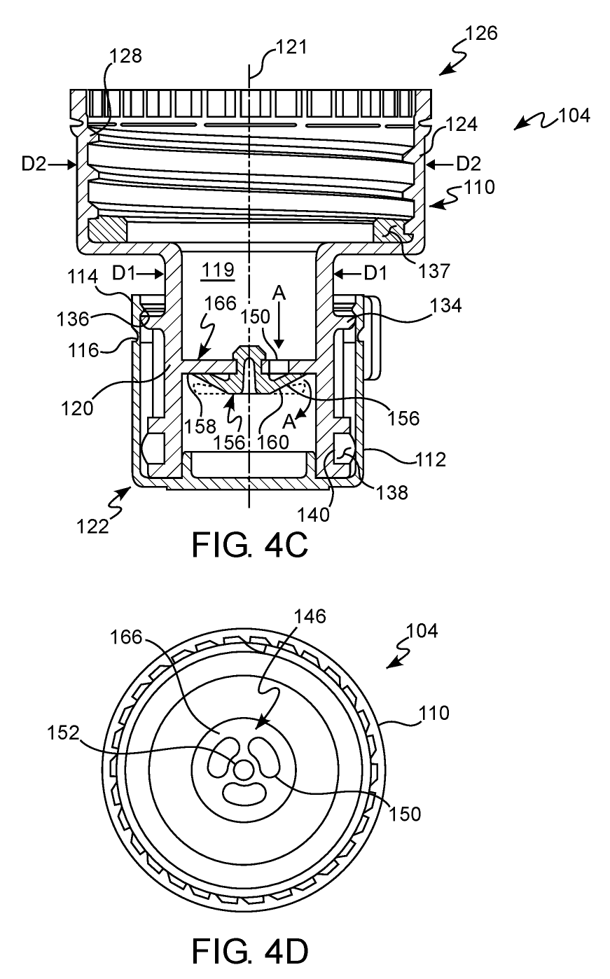

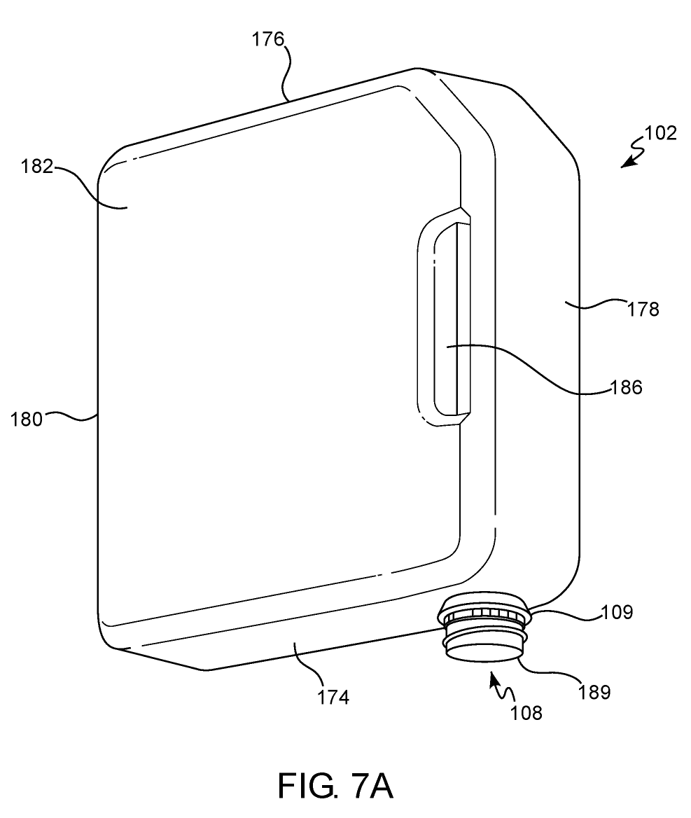

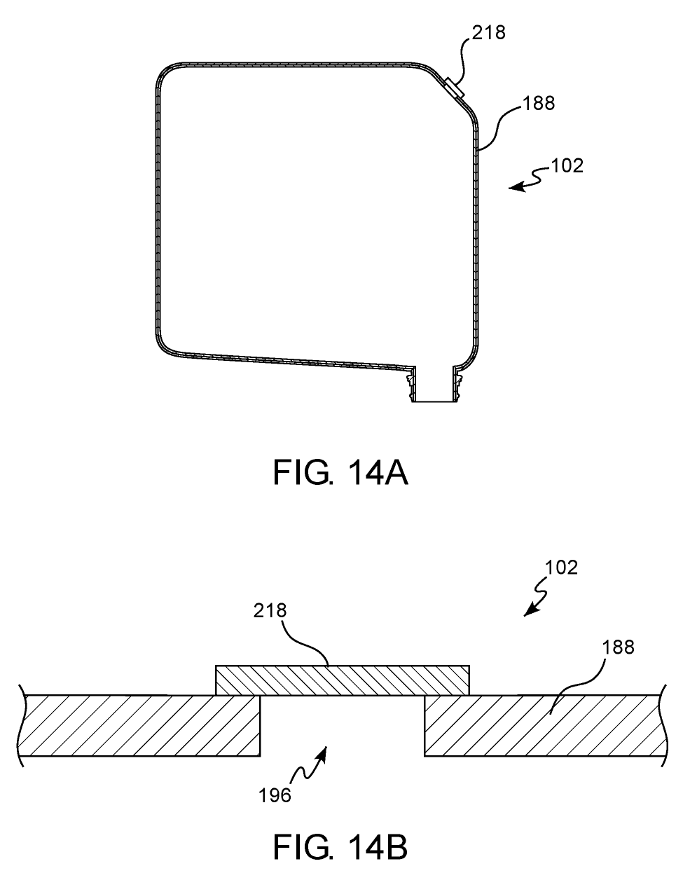

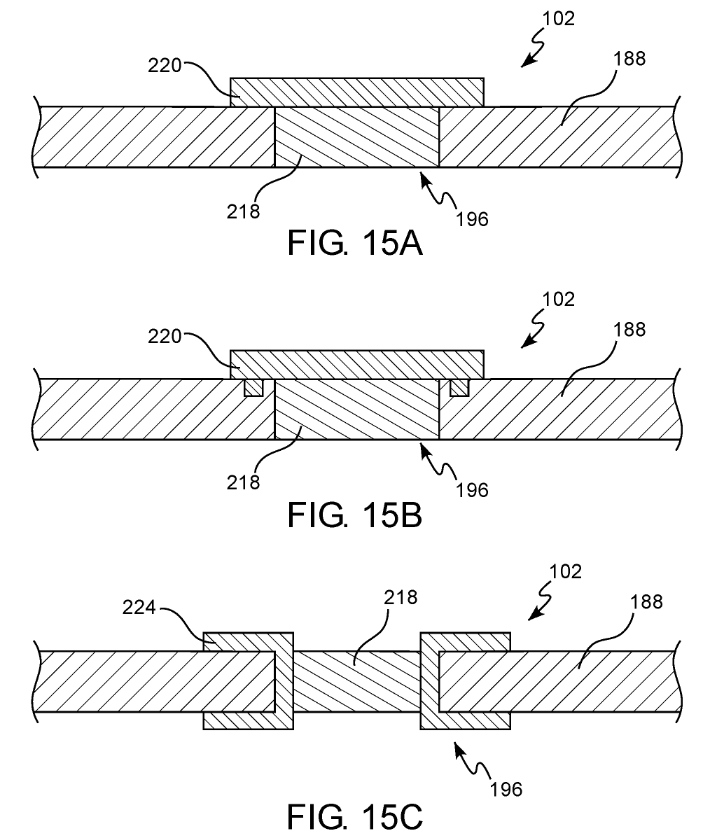

With reference to FIGS. 4A-4B, the fitment 104 is shown in accordance with some examples or aspects of the present disclosure. The fitment 104 shown in FIGS. 4A-4B is configured to have a one-way valve for dispensing liquid outer of the container 102 and without allowing liquid to go back into the container 102. The fitment 104 is suitable for use with a container 102 having a vent, such as the container 102 described herein with reference to FIGS. 7A-7D or the container 102 described with reference to FIGS. 14A-15C. The fitment 104 generally has a body 110 and a protective cap 112. The protective cap 112 is removably connected to the body 110. In some examples, the protective cap 112 may be initially connected with the body 110 with a removable strip 114 that must be removed prior to removing the protective cap 112 from the body 110. The cap 112 and the removable strip 114 thus seal the body 110 and prevent inadvertent removal of the cap 112. In this manner, the removable strip 114 is provided as a tamper-evident security device that, when removed, indicates that the protective cap 112 may have been removed from the body 110. In some examples or aspects, the removable strip 114 may be monolithically formed with the protective cap 112. For example, a predefined weakened portion 116 (shown in FIG. 4C) may be provided for separating the removable strip 114 from the protective cap 112 when a tab 118 (shown in FIG. 4C) is pulled.

With continued reference to FIGS. 4A-4B, an outer side of a proximal portion 124 of the body 110 may have one or more gripping elements 130 to provide a gripping surface for the user during handling of the fitment 104. For example, the one or more gripping elements 130 may be configured as a series of recesses and protrusions on an outer surface of the proximal portion 124 of the body 110. The proximal portion 124 may further have a pair of flat portions 132 positioned opposite one another about an outer circumference of the proximal portion 132. The flat portions 132 provide an increased surface contact with the user's fingers during installation and removal of the fitment 104.

With reference to FIG. 4C, the body 110 of the fitment 104 has a substantially hollow shape with an interior channel 119. The body 110 has a distal portion 120 at its distal end 122 configured for interacting with at least a portion of the dispensing apparatus 10, such as the nest 14 (shown in FIG. 2), and a proximal portion 124 at its proximal end 126 configured for interacting with the container 102 (shown in FIG. 3B). An interior of the body 110 is hollow to allow the passage of the liquid through the channel 119. The body 110 may have a substantially annular shape with a central axis 121 extending through a center of the channel 119. In some examples or aspects, the distal portion 120 may have a different outer diameter compared to the proximal portion 124. For example, the distal portion 120 may have a first diameter D1 that is smaller than a second diameter D2 of the proximal portion 124.

The proximal portion 124 has a second connection element 128 configured for interacting with the first connection element 108 on the discharge spout 109 of the container 102 (shown in FIG. 3B). In some examples or aspects, the second connection element 128 may be an internal female thread configured for removably connecting the body 110 to the first connection element 108 on the discharge spout 109 of the container 102. The first connection element 108 on the container 102 and the second connection element 128 on the fitment 104 may have a helical shape. In further examples or aspects, the proximal portion 124 of the body 110 may be connected to the discharge spout 109 of the container 102 using, for example, a friction fit, an interference fit, an adhesive fit, a clip, connector, fastener, or any other removable connection mechanism. In further examples, the proximal portion 124 of the body 110 may be non-removably connected to the discharge spout 109 of the container 102 using, for example, an adhesive, friction or ultrasonic welding, a permanent mechanical connection, or other non-removable connection mechanism.

With continued reference to FIG. 4C, the distal portion 120 of the body 110 has a flange 134 that extends around at least a portion of its outer circumference. The flange 134 protrudes radially outward from the outer surface of the distal portion 120 and is configured for engaging a lip 136 on the removable strip 114. The interaction between the flange 134 and the lip 136 prevents the removal of the protective cap 112 prior to removal of the removable strip 114.

With continued reference to FIG. 4C, a first seal 137 may be provided on the proximal portion 124 of the body 110. The first seal 137 may be configured for providing a seal at the discharge spout 109 on the open end 106 of the container 102 (shown in FIG. 3B) to prevent leakage of liquid from the container 102 past the fitment 104. The first seal 137 may an O-ring that is retained in at a base 144 of the proximal portion 124 of the body 110. The first seal 137 is configured for interacting with at least a portion of the container 102, such as the discharge spout 109, when the fitment 104 is connected to the container 102. The first seal 137 is desirably made from an elastomeric material, such as silicone, rubber, a thermoplastic elastomer, or other flexible material. In some examples or aspects, the first seal 137 may be monolithically formed with the body 110 of the fitment 104. For example, the second seal 138 may be co-molded with the body 110 such that the first seal 137 and the body 110 form a single, integral component. In other examples or aspects, the first seal 137 is formed as a separate component from the body 110 and is placed at the base 144 of the proximal portion 124 of the body 110. In further examples or aspects, the first seal 137 may be provided on an outer surface of the discharge spout 109 of the container 102.

With continued reference to FIG. 4C, a second seal 138 may be provided on the distal portion 120 of the body 110 such that the second seal 138 contacts at least a portion of the cap 112 and seals the distal portion 120 of the body 110 from contamination. The second seal 138 may an O-ring that is retained in a groove 140 at the distal portion 120 of the body 110. In some examples or aspects, the second seal 138 can be provided at the distal end 122 of the fitment 104 without the groove 140. The second seal 138 is configured for interacting with at least a portion of the dispensing apparatus 10 when the protective cap 112 is removed, such as via contact with an inner sidewall of the nest 14, to allow the actuator 16 to draw liquid form the container 102 via a vacuum force. The second seal 138 is desirably made from an elastomeric material, such as silicone, rubber, a thermoplastic elastomer, or other flexible material. In some examples or aspects, the second seal 138 may be monolithically formed with the body 110 of the fitment 104. For example, the second seal 138 may be co-molded with the body 110 such that the second seal 138 and the body 110 form a single, integral component. In other examples or aspects, the second seal 138 is formed as a separate component from the body 110 and is placed in the groove 140. In further examples or aspects, the second seal 138 may be provided on an inner portion of the cap 112 such that the second seal 138 contacts at least a portion of the body 110 and seals the distal portion 120 of the body 110 from contamination.

With reference to FIGS. 4C-4D, the distal portion 120 of the body 110 has a partition 146 extending across the interior of the body 110. The partition 146 acts as a valve seat for a valve that controls fluid flow through the fitment 104. The partition 146 is connected to an inside surface 148 of the channel 119 and extends in a direction that is substantially perpendicular to the central axis 121. In some examples, the partition 146 may extend at a non-perpendicular angle relative to the central longitudinal axis 121. In some examples or aspects, the partition 146 is monolithically formed with the distal portion 120 of the body 110. In other examples, the partition 146 is formed as a separate component that is removably or non-removably connected to the inside surface 148 of the channel 119. In further examples, the partition 146 may be connected to any other inner surface of the body 110.

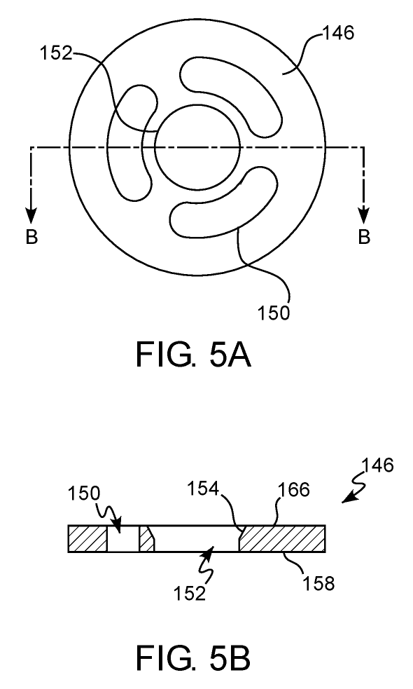

With reference to FIGS. 5A-5B, the partition 146 has one or more apertures 150 extending therethrough in a direction along the central longitudinal axis 121. In some examples where a plurality of apertures 150 are provided, the apertures 150 may be spaced apart about the central longitudinal axis 121 at equal or unequal radial intervals. In some examples or aspects, each aperture 150 may have an identical shape to other apertures 150. In other examples or aspects, the apertures 150 may have a different shape from each other. While FIGS. 5A-5B show three kidney-shaped apertures 150, other number of apertures 150 and/or shapes of the apertures 150 are not precluded. For example, a plurality of apertures 150 may be separated by spokes extending about the central longitudinal axis 121. The number and size of apertures 150 is selected based on the characteristics of the liquid to be dispensed through the fitment 104. The partition 146 further has a central opening 152 substantially coaxial with the central longitudinal axis 121. The central opening 152 is configured for receiving at least a portion of a valve, as described herein. In some examples or aspects, a proximal end of the central opening 152 may have a beveled edge 154, such as shown in FIG. 5B.

With reference to FIG. 4C, the fitment 104 has a valve 156 configured for regulating a passage of fluid through the channel 119 of the fitment 104. In some examples or aspects, the valve 156 may be connected to at least a portion of the partition 146 (shown in FIG. 4D). For example, the valve 156 may be connected to the partition 146 by way of the central opening 152. The valve 156 may be movable between a normally-closed position seated against a distal surface 158 of the partition 146 to close the at least one aperture 150, and an open position (shown by dotted lines) at least partially unseated from the distal surface 158 of the partition 146 to open the at least one aperture 146. The valve 156 may be a one-way valve that allows fluid flow in a direction from the proximal end of the fitment 104 toward the distal end, and prevents fluid flow in a reverse direction from the distal end towards the proximal end. In the closed position, the valve 156 prevents the passage of liquid from the container 102 through the at least one aperture 150 of the partition 146. In the open position, the valve 156 allows the liquid form the container 102 to flow through the at least one aperture 150 of the partition 146 such that liquid can exit the container 102 via the channel 119 of the fitment 104 in a direction of arrow A.

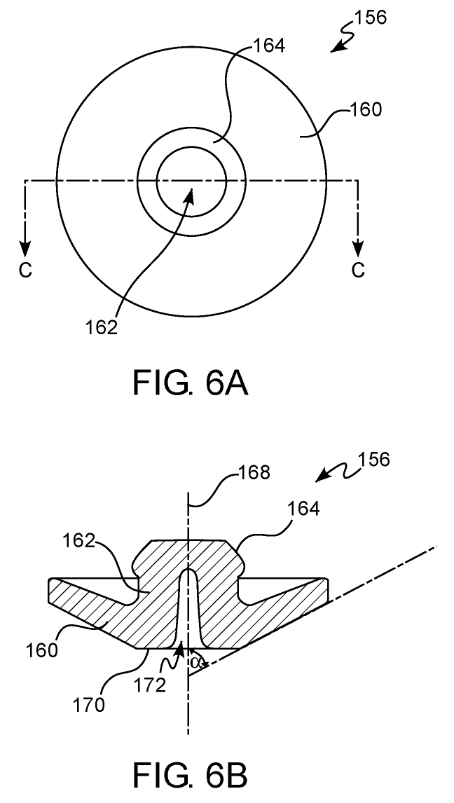

With reference to FIGS. 6A-6B, the valve 156 may be, with some examples, an umbrella valve having a sealing portion 160 and a stem 162 extending proximally of the sealing portion 160. A proximal end of the sealing portion 160 is configured to engage a distal surface 158 of the partition 146 which acts as a valve seat (see FIG. 4D). The stem 162 of the valve 156 is configured to extend through the central opening 152 of the partition 146 to secure the valve 156 axially relative to the partition 146. In some examples, a proximal end of the stem 162 may have a lip 164 that protrudes radially outward relative to a body of the stem 162. The lip 164 may be dimensioned such that its outer diameter is larger than an inner diameter of the central opening 152 of the partition 146. When the valve 156 is connected to the partition 146, such as shown in FIG. 4D, the lip 164 may engage a proximal surface 166 of the partition 146 to prevent axial movement of the valve 156 relative to the partition 146 in a direction along the central axis 121. The valve 156 is normally closed such that the sealing portion 160 is seated against the distal surface 158 of the partition 146, thereby blocking the apertures 150 and preventing the passage of liquid through the apertures 150. The sealing portion 160 is configured to deflect, such as by folding the outer edges of the sealing portion 160 away from the distal surface 158 of the partition 146, when the liquid pressure on the proximal side of the sealing portion 160 exceeds the pressure on the distal side of the sealing portion 160. In some examples or aspects, the sealing portion 160 may have a thickness between 0.5 mm to 2.5 mm. In further examples or aspects, the stem 162 may have a diameter between 1.0 mm to 7.0 mm.

With reference to FIG. 6B, the sealing portion 162 may be angled at an angle α relative to a longitudinal axis 168 of the stem 162. Angle α may be 55° to 90°. In some examples or aspects, a distal surface 170 of the sealing portion 160 may be flat. In some examples or aspects, a relief 172 may extend longitudinally through the stem 162 from the distal surface 170 of the sealing portion 160 in a direction of the longitudinal axis 168.

In some examples, the valve 156 is desirably made from an elastomeric material, such as silicone, rubber, thermoplastic elastomer, or other flexible material. In some examples or aspects, the valve 156 may be monolithically formed with the body 110 of the fitment 104. For example, the valve 156 may be co-molded with the body 110 such that the valve 156 and the body 110 form a single, integral component. In other examples or aspects, the valve 156 is formed as a separate component from the body 110 and is inserted into the central opening 152 of the partition 146. In other examples or aspects, the valve 156 may be any other kind of one-way valve configured to allow passage of liquid in a proximal-to-distal direction of the fitment 104.

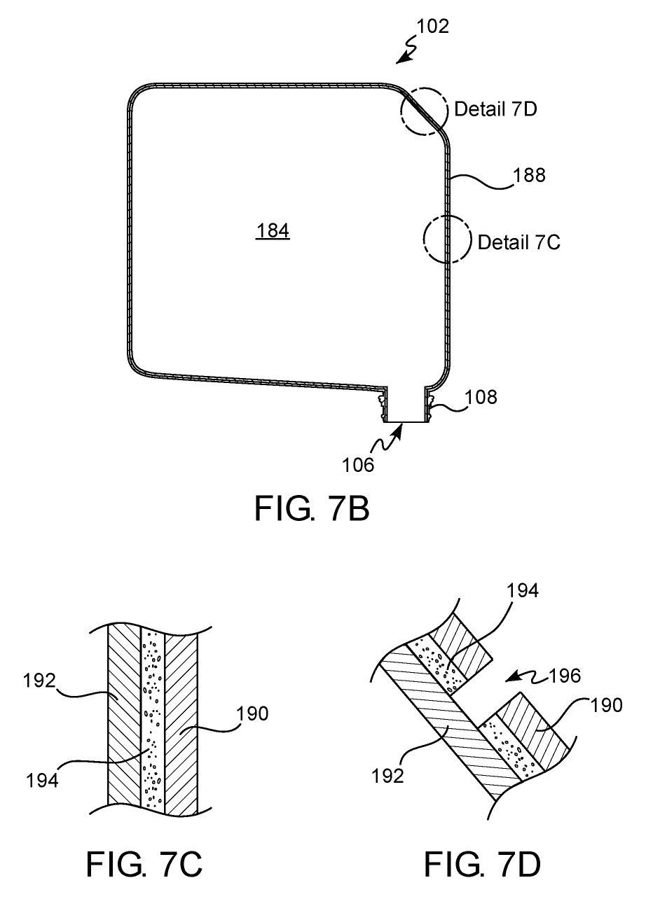

With reference to FIG. 7A, the container 102 has an open bottom side 174, a closed top side 176, a front side 178, a rear side 180, and a pair of lateral sides 182. The open end 106 with the discharge spout 109 is defined on the open bottom side 174. The sides 174-182 define a container interior 184 (shown in FIGS. 8A-8B). The container interior 184 is configured for receiving a liquid, such as a liquid beverage concentrate or other liquid substance. The container 102 may have a recessed portion 186 on at least one of the sides 174-182. The recessed portion 186 may be configured for facilitating the gripping of the container 102 during insertion into and removal from the receiving space 12 of the dispensing apparatus 10 (shown in FIG. 1). A removable dust cap 189 may be provided for enclosing the open end 106 prior to attachment of the fitment 104 to the container 102.

With reference to FIG. 7B, the container 102 has a sidewall 188 defining the container interior 184. In some examples or aspects, the sidewall 188 may be a multi-layer sidewall 188. For example, with reference to FIG. 7C, the sidewall 188 may have an outer layer 190, an inner layer 192, and an intermediate layer 194 between the outer layer 190 and the inner layer 192. In other examples or aspects, the sidewall 188 may have any number of layers, such as from two to seven layers. In some examples or aspects, the outer layer 190 may be a rigid layer formed from polyethylene material. The inner layer 192 may be a flexible layer formed form ethylene vinyl alcohol material. The inner layer 192 defines the container interior 184. The inner layer 192 may be releasably connected to the outer layer 190 via the intermediate layer 194. The intermediate layer 194 may remain connected to the outer layer 190 as the inner layer 192 is released. In some examples or aspects, the sidewall 188 may only have the outer layer 190 and the inner layer 192 without the intermediate layer 194. In some examples or aspects, the intermediate layer 194 may be an adhesive that releasably holds the inner layer 192 connected to the outer layer 190. In other examples or aspects, the intermediate layer 194 may be a release layer or an oxygen barrier.

With reference to FIG. 7D, the container 102 has at least one vent 196. In some examples or aspects, the at least one vent 196 may extend through the outer layer 190 and terminate at an outer surface of the intermediate layer 194. In other examples or aspects, the at least one vent 196 may extend through the outer layer 190 and the intermediate layer 194, and terminate at an outer surface of the inner layer 192.

With reference to FIGS. 8A-8B, the at least one vent 196 is configured to allow air to enter into the container 102 to fill a space 198 between the outer layer 190 and the inner layer 192 as the inner layer 192 is released or delaminated from the outer layer 190. For example, when the fitment 104 is connected to the actuator 16 of the dispensing apparatus 10 (shown in FIG. 2), a vacuum is drawn to force the valve 156 to open. As the valve 156 opens, liquid from the container interior 184 can be delivered from the container 102 through the fitment 104. As the liquid is delivered from the container interior 184, the inner layer 192 delaminates from the outer layer 190 (and the intermediate layer 194, if so equipped), thereby creating the space 198 between the inner and outer layers 192, 190. The at least one vent 196 allows air to enter the space 192, but not the container interior 184. In this manner, the liquid inside the container interior 184 can be kept from being contaminated from contact with any particulates contained in the air outside the container 102. The at least one vent 196 may be produced in any desired manner, such as by drilling or punching the vent after manufacture of the container 102, or during manufacture of the container 102.

Having described the structure of the liquid dispense system 100, a method of dispensing liquid from the container 102 via the fitment 104 will now be described. Initially, the liquid dispense system 100 is connected to the dispensing apparatus 10 (shown in FIG. 1), such as by inserting the fitment 104 into the nest 14 of the dispensing apparatus 10. Once inserted, the second seal 138 on the distal portion 120 of the fitment 104 seals against an inner surface of the nest 14 such that an air tight seal is created between the distal portion 120 and the actuator 16. The actuator 16 is configured to pull a vacuum, such as using a vacuum pump, thereby lowering the pressure proximally of the sealing portion 160 of the valve 156 relative to the pressure distally of the sealing portion 160. This difference in pressure causes the sealing portion 160 of the valve 156 to deflect axially away from contacting the distal surface 158 of the partition 146, thereby opening the apertures 150. Because a pressure on a distal side of the partition 146 is lower than a pressure inside the container 102, liquid within the container 102 is delivered through a space defined between the apertures 150 and the deflected sealing portion 160 of the valve 156. As the liquid is dispensed from the container 102, the inner layer 192 of the sidewall 188 delaminates or releases from the outer layer 190, thereby collapsing the bag defined by the inner layer 192. As the inner layer 192 is delaminated or released from the outer layer 190, air is introduced into the space 198 between the inner layer 192 and the outer layer 190. When the pressure proximally of the sealing portion 160 of the valve 156 is equalized with the pressure distally of the sealing portion 160, such as by turning off the vacuum pump of the actuator, the sealing portion 160 of the valve 156 reverts to its initial position and contacts the distal surface 158 of the partition 146 to seal the apertures 150 and prevent further passage of liquid there through in a direction out of the container 102 or into the container 102. In this manner, the liquid dispense system 100 allows for delivery of liquid from the container 102 without introducing outside air into the container interior 184. Furthermore, due to the normally closed configuration of the valve 156, the fitment 104 is configured to prevent movement of fluid in a direction from the distal end toward the proximal end of the fitment 104.

The container 102 can be made from any material that is impervious to liquid and/or gas, such as glass, plastic, or metal. In some examples or aspects, the container 102 is made from a plastic material, such as high density polyethylene (HDPE). The container 102 may be made from a transparent, translucent, or opaque material. In some examples, the container 102 may be made using a blow molding or an injection molding process.

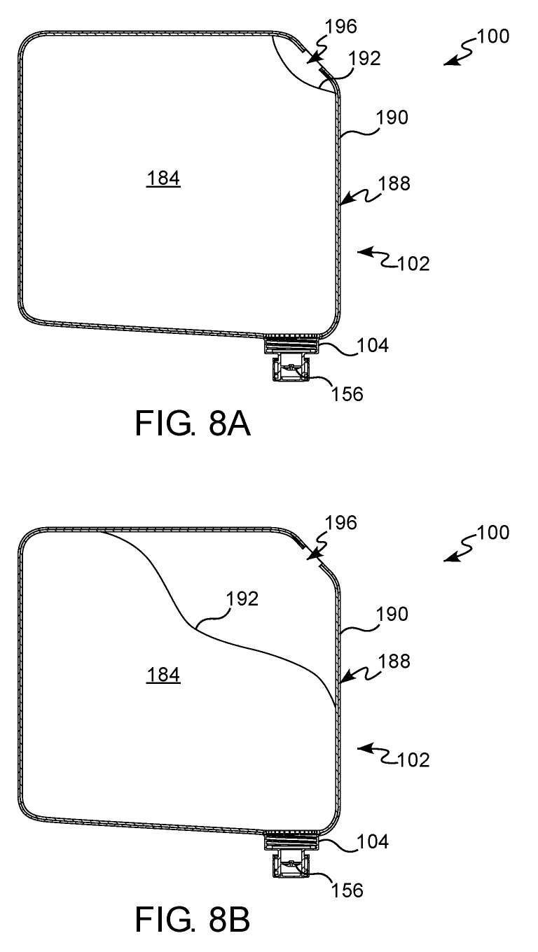

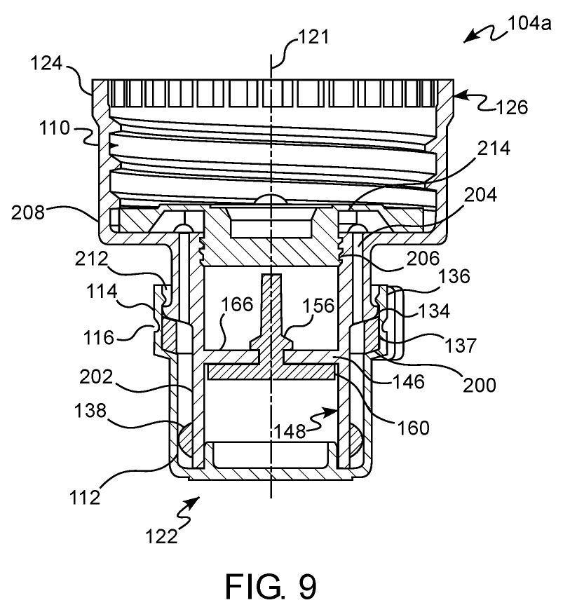

With reference to FIGS. 9-10B, a fitment 104a is shown in accordance with another example or aspect of the present disclosure. The fitment 104a may be configured for use with the container 102 described herein with reference to FIGS. 7-8B or with a non-vented container 102. The fitment 104a shown in FIGS. 9-10B is configured to allow two-way liquid flow to enable dispensing of liquid from the container 102 and filling the container 102 with liquid. The components of the fitment 104a shown in FIGS. 9-10B are substantially similar to the components of the fitment 104 described herein with reference to FIGS. 4A-4D. Accordingly, reference numerals in FIGS. 9-10B are used to illustrate identical components of the corresponding reference numerals in FIGS. 4A-4D. As the previous discussion regarding the fitment 104 generally shown in FIGS. 4A-4D is applicable to the fitment 104a shown in FIGS. 9-10B, only the relative differences between the two fitments are discussed hereinafter.

With reference to FIG. 9, the distal portion 120 of the body 110 narrows in a direction distal from the flange 134 such that a circumferential sill 200 is defined between the flange 134 and a narrowed portion 202 at the distal end 122 of the fitment 104a. The sill 200 may be angled relative to a central longitudinal axis 121 of the fitment 104a. The sill 200 has one or more openings 204 extending between the exterior of the fitment 104a and the interior of the fitment 104a. In some examples or aspects where a plurality of openings 204 are provided (FIG. 10A), the openings 204 may be spaced apart about the central longitudinal axis 121 at equal or unequal radial intervals. The openings 204 may have a same or different diameter. In some examples, a diameter of the openings 204 may be between ⅛ in. and ¼ in. The diameter of the openings 204 is desirably selected to allow the passage of air in a direction from the distal end 122 toward the proximal end 126 of the fitment 104a while fluid is delivered in a direction from the proximal end 126 toward the distal end 122, such as during liquid dispensing from the container 102. In addition, the diameter of the openings 204 is desirably selected to allow the passage of liquid in a direction from the distal end 122 toward the proximal end 126 of the fitment 104a while air is withdrawn from the container interior in a direction from the proximal end 126 toward the distal end 122, such as during filling of the container with liquid.

With continued reference to FIG. 9, the fitment 104a has an insert 206 positioned within the central channel 119 of the fitment 104a. The insert 206 is desirably made from an elastomeric material, such as silicone, rubber, thermoplastic elastomer, or other flexible material. In some examples or aspects, the insert 206 is positioned within the central channel 119 of the fitment 104a at a transition between the distal portion 120 and the proximal portion 124. The insert 206 may have a flange 208 that abuts the inside surface 148 of the fitment 104a at the proximal portion 124. An insert body 210 extends distally from the flange 208 and contacts the inside surface 148 of the distal portion 120. In some examples, the insert body 210 may have one or more ribs 212 that contact the inside surface 148 of the distal portion 120.

With reference to FIGS. 9 and 10B, the insert 206 has one or more vents 214. In some examples or aspects, the one or more vents 214 is provided on the flange 208 and extends between the proximal and distal surfaces of the flange 208. In some examples or aspects where a plurality of vents 214 are provided, the vents 214 may be spaced apart about the central longitudinal axis 121 at equal or unequal radial intervals. The vents 214 may be configured as slits in the material of the insert 206.

The vents 214 may be normally closed and move to an open position to allow the passage of air in a direction from the distal end 122 toward the proximal end 126 of the fitment 104a while the liquid is delivered in a direction from the proximal end 126 toward the distal end 122 through the insert 206. In this manner, during dispensing of the liquid from the container 102, while the liquid is delivered from the container 102 in a direction from the proximal end 126 toward the distal end 122 through the insert 206, air is introduced into the container interior by flowing through the openings 204 in the body 110 of the fitment 104a and through the vents 214 in the insert 206. The vents 214 may be further configured to allow the passage of liquid in a direction from the distal end 122 toward the proximal end 126 of the fitment 104 during filling of the container 102 with liquid. In this manner, while the air is withdrawn from the container 102 in a direction from the proximal end 126 toward the distal end 122 of the fitment 104a through the insert 206, liquid is introduced into the container interior by flowing through the openings 204 in the body 110 of the fitment 104 and through the vents 214 in the insert 206.

Having described the structure of the fitment 104a, a method of dispensing liquid from the container 102 and a method of filling the container 102 with liquid using the fitment 104a will now be described. The fitment 104a is configured for a three-way operation: dispensing of liquid from the container 102, filling the container 102 with liquid, and preventing ingress of residual material in the nest 14 into the container 102. During dispensing of liquid from the container 102, the distal portion 120 of the body 110 is connected to an actuator (not shown), such that an air tight seal is created between the distal portion 120 of the body 110 and the actuator. In some examples, the seal may be created due to interaction of the second seal 138 and at least a portion of the actuator. A vacuum is pulled by the actuator, such as using a vacuum pump, thereby lowering the pressure proximally of the sealing portion 160 of the valve 156 relative to the pressure distally of the sealing portion 160. This difference in pressure causes the sealing portion 160 of the valve 156 to deflect axially away from contacting the distal surface 158 of the partition 146, thereby opening the apertures 150. Liquid within the container 102 passes through a space defined between the apertures 150 and the deflected sealing portion 160 of the valve 156. As the liquid is dispensed from the container 102, air is introduced into the container 102 by flowing through the openings 204 on the body 110 and the vents 214. When the pressure proximally of the sealing portion 160 of the valve 156 is equalized with the pressure distally of the sealing portion 160, such as by turning off the vacuum pump of the actuator, the sealing portion 160 of the valve 156 reverts to its initial position and contacts the distal surface 158 of the partition 146 to seal the apertures 150 and prevent further passage of liquid therethrough in a direction out of the container 102 or into the container 102.

During filling of an empty container 102 with liquid, the distal portion 120 of the body 110 is connected to an actuator (not shown), such that an air tight seal is created between the distal portion 120 of the body 110 and the actuator. Liquid is delivered under pressure higher than the pressure within the container 102 through the openings 204 in the fitment 104a and the vents 214. As the liquid fills the container 102, air pressure in the container is higher than air pressure distally of the sealing portion 160 of the valve 156. This difference in pressure causes the sealing portion 160 of the valve 156 to deflect axially away from contacting the distal surface 158 of the partition 146, thereby opening the apertures 150. Air from the container 102 passes through a space defined between the apertures 150 and the deflected sealing portion 160 of the valve 156. Stopping the delivery of liquid to the container 102 equalizes the pressure proximally of the sealing portion 160 of the valve 156 with the pressure distally of the sealing portion 160, thereby causing the sealing portion 160 of the valve 156 to revert to its initial position and contact the distal surface 158 of the partition 146 to seal the apertures 150 and prevent further passage of air therethrough in a direction out of the container 102 or into the container 102.

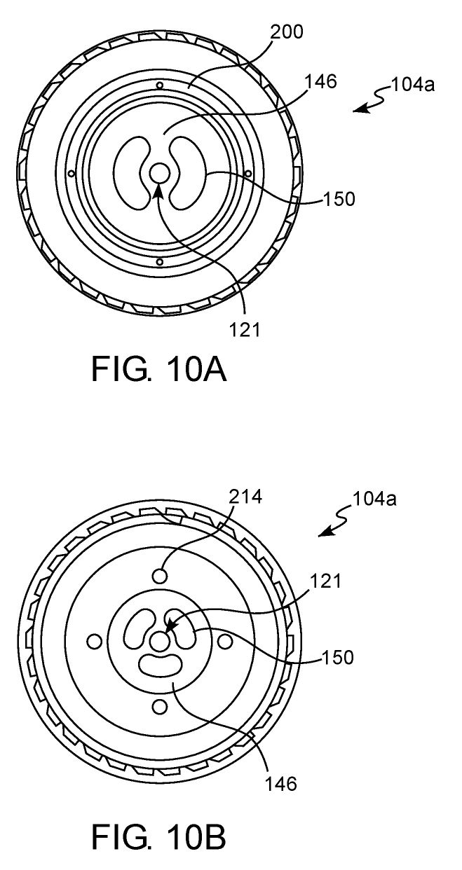

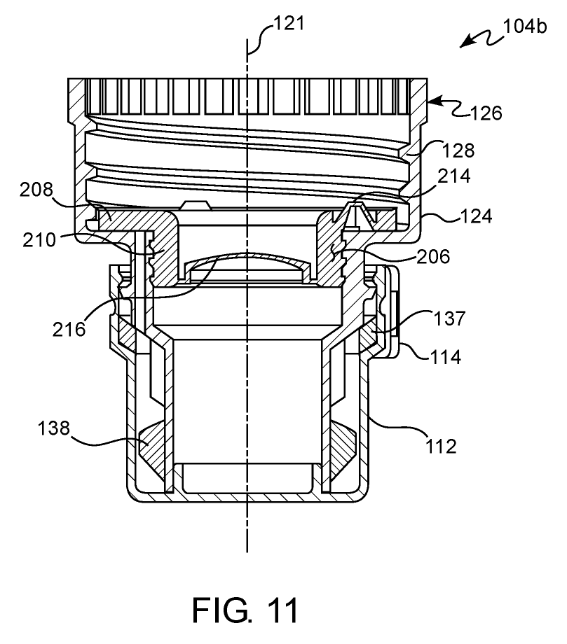

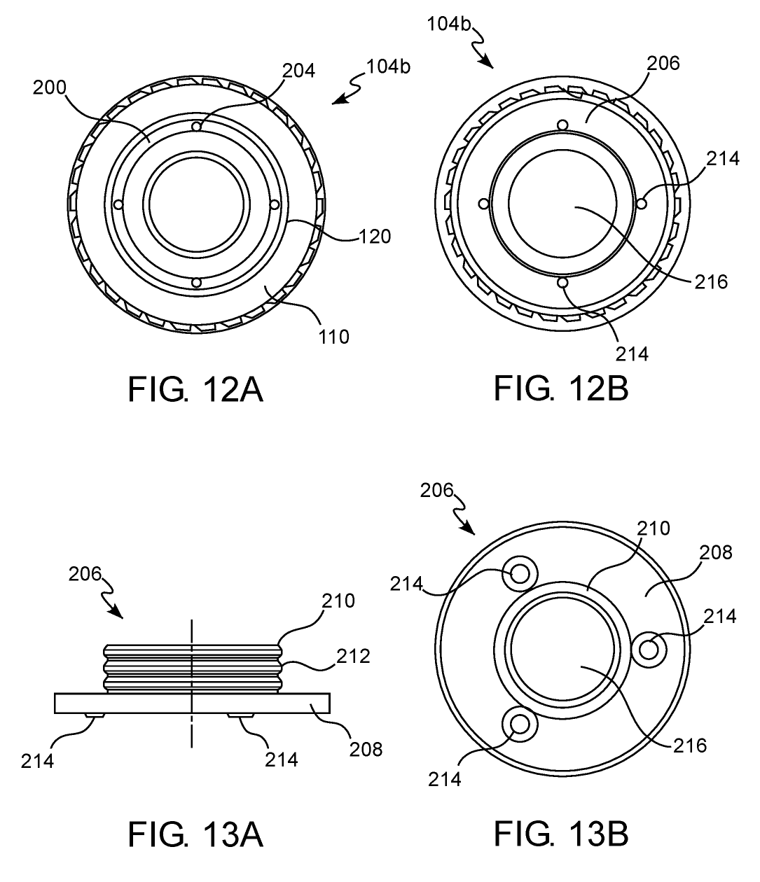

With reference to FIGS. 11-13B, a fitment 104b is shown in accordance with another example or aspect of the present disclosure. The fitment 104b may be configured for use with the container 102 described herein with reference to FIGS. 7-8B or with a non-vented container 102. The fitment 104b shown in FIGS. 9-10B is configured to allow two-way liquid flow to enable dispensing of liquid from the container 102 and filling the container 102 with liquid. The components of the fitment 104b shown in FIGS. 11-13B are substantially similar to the components of the fitment 104a described herein with reference to FIGS. 9-10B. Reference numerals in FIGS. 11-13B are used to illustrate identical components of the corresponding reference numerals in FIGS. 9-10B. As the previous discussion regarding the fitment 104a generally shown in FIGS. 9-10B is applicable to the fitment 104b shown in FIGS. 11-13B, only the relative differences between the two fitments are discussed hereinafter.

Rather than having a hollow insert 206, the insert 206 of the fitment 104b has a piercable membrane 216 extending across the perimeter sidewall of the insert body 210. In some examples, the piercable membrane 216 has a reduced thickness in a central portion thereof to facilitate piercing. The piercable membrane 216 is configured for being pierced by at least a portion of the dispensing apparatus 10, such as at least a portion of the actuator 16 (shown in FIG. 1).

With reference to FIGS. 14A-15C, the container 102 may have at least one vent 196 with a protective membrane 218 covering at least a portion of the vent 196. The container 102 shown in FIGS. 14A-15C may be used with any of the fitments 104, 104a, 104b described herein. In some examples or aspects, the protective membrane 218 may be configured to prevent micro-organisms, particulates, liquids, or other contaminates present in the ambient air from entering the container 102 and mixing with the liquid contained within the container 102. The protective membrane 218 may be configured to repel contaminates that may be in the ambient air and ensure a filtered pressure equalization between the container 102 and the ambient air located outside of the container 102. The protective membrane 218 also may be configured to retain the liquid inside of the container 102 from spilling from the container 102 through the vent 196. The protective membrane 218 may be permanently affixed to the container 102 during the production process, such as by an adhesive or ultrasonic welding. In some examples or aspects, the protective membrane 218 may be made from a polytetrafluoroethylene (PTFE) material or a porous plastic material.

With reference to FIG. 15A, the protective membrane 218 may have a pull tab 220 that covers the protective membrane 218 and vent 196. In some examples or aspects, the pull tab 220 may be connected to at least a portion of the container 102 to cover the protective membrane 218 and the vent 196 during manufacture of the container 102. Prior to use of the container 102, the pull tab 220 may be removed to expose the protective membrane 218.

With reference to FIG. 15B, the protective membrane 218 may have a protective cap 222 that covers the protective membrane 218 and vent 196. In some examples or aspects, the protective cap 222 may be connected to at least a portion of the container 102 to cover the protective membrane 218 and the vent 196 during manufacture of the container 102. Prior to use of the container 102, the protective cap 222 may be removed to expose the protective membrane 218. The protective cap 222 may be attached to the container 102 in such a way so that removal of the protective cap 222 from the container 102 will not damage the container 102, the protective membrane 218, or the vent 196. With reference to FIG. 15C, the protective membrane 218 may be built into a membrane element 224 that is affixed to the container 102, such as the sidewall 188 of the container 102.

While various examples or aspects of a liquid dispense system are provided in the foregoing description, those skilled in the art may make modifications and alterations to these examples or aspects without departing from the scope and spirit of the disclosure. Accordingly, the foregoing description is intended to be illustrative rather than restrictive. The disclosure described hereinabove is defined by the appended claims, and all changes to the disclosure that fall within the meaning and the range of equivalency of the claims are to be embraced within their scope.

We claim:

1. A liquid dispense system comprising:
a container having an open end and a sidewall defining a container interior, the sidewall comprising at least one vent; and
a fitment enclosing the open end of the container, the fitment comprising:
a hollow body having a partition extending across an interior of the hollow body, the partition having at least one aperture; and
a valve connected to at least a portion of the partition, the valve movable between a normally-closed position seated against the distal surface of the partition to close the at least one aperture, and an open position at least partially unseated from the distal surface of the partition to open the at least one aperture,
wherein the at least one vent is covered by a protective membrane configured to filter air that enters the container interior as liquid is dispensed from the container interior when the valve is in the open position.

2. The liquid dispense system according to claim 1, wherein the valve has a stem portion with a proximal end connected to the partition and a seal portion extending radially outward from a distal end of the stem portion, the seal portion configured for sealing the at least one aperture.

3. The liquid dispense system according to claim 1, wherein the hollow body has a proximal portion connected to the open end of the container and a distal portion configured for interacting with a dispensing apparatus.

4. The liquid dispense system according to claim 1, wherein the at least one vent is positioned opposite the open end of the container.

5. The liquid dispense system according to claim 1, wherein the protective membrane is made from a polytetrafluoroethylene material.

6. The liquid dispense system according to claim 1, wherein the hollow body of the fitment is made from a first material and the valve is made from a second material different from the first material.

7. The liquid dispense system according to claim 6, wherein the first material is high density polyethylene.

8. The liquid dispense system according to claim 6, wherein the second material is a thermoplastic elastomer.

9. The liquid dispense system according to claim 1, wherein the open end of the container has a first connection element and wherein a proximal portion of the fitment has a second connection element configured for connecting with the first connection element.

10. The liquid dispense system according to claim 9, wherein the first connection element is a male thread and wherein the second connection element is a female thread releasably connectable with the male thread.

11. The liquid dispense system according to claim 1, wherein at least one of the open end of the container and a proximal portion of the fitment has a first seal configured for sealing the open end of the container when the proximal portion of the fitment is connected to the open end of the container.

12. The liquid dispense system according to claim 1, wherein an outer surface of the distal end of the fitment has a second seal.

13. The liquid dispense system according to claim 1, further comprising a protective cap at least partially surrounding a distal portion of the fitment.

14. The liquid dispense system according to claim 13, wherein the protective cap has a removable strip configured for preventing removal of the protective cap from the distal portion of the fitment prior to removal of the removable strip.

15. The liquid dispense system according to claim 14, wherein an outer surface of the distal portion of the fitment has a flange protruding in a radially outward direction, the flange configured for engaging a lip on the removable strip to prevent removal of the protective cap from the distal portion of the fitment prior to removal of the removable strip.

16. A liquid dispense system comprising:
a container having an open end and a sidewall defining a container interior, the sidewall having at least one vent; and
a fitment enclosing the open end of the container, the fitment comprising:
a hollow body having a proximal portion connected to the open end of the container and a distal portion configured for interacting with a dispensing apparatus;
a partition extending across an interior of the hollow body, the partition having at least one aperture; and
a valve having a stem portion with a proximal end connected to the partition and a seal portion extending radially outward from a distal end of the stem portion, the seal portion movable between a normally-closed position seated against the distal surface of the partition to close the at least one aperture, and an open position at least partially unseated from the distal surface of the partition to open the at least one aperture,
wherein the at least one vent is covered by a protective membrane configured to filter air that enters the container interior as liquid is dispensed from the container interior when the valve is in the open position.

17. The liquid dispense system according to claim 16, wherein the hollow body of the fitment is made from a first material and the valve is made from a second material different from the first material.

18. The liquid dispense system according to claim 17, wherein the first material is high density polyethylene, and wherein the second material is a thermoplastic elastomer.

19. The liquid dispense system according to claim 16, wherein at least one of the open end of the container and a proximal portion of the fitment has a first seal configured for sealing the open end of the container when the proximal portion of the fitment is connected to the open end of the container.

20. The liquid dispense system according to claim 16, wherein an outer surface of the distal end of the fitment has a second seal.
